(19) United States
(12) Patent Application Publication
(10) Pub. No.: US 2022/0308888 A1
(43) Pub. Date: Sep. 29, 2022

(54) METHOD FOR REDUCING LOST CYCLES AFTER BRANCH MISPREDICTION IN A MULTI-THREAD MICROPROCESSOR

(71) Applicant: Redpine Signals, Inc., San Jose, CA (US)

(72) Inventor: Heonchul PARK, Cupertino, CA (US)

(73) Assignee: Redpine Signals, Inc., San Jose, CA (US)

(21) Appl. No.: 17/214,805

(22) Filed: Mar. 27, 2021

(51) Int. Cl. G06F 9/38; G06F 9/30

(52) U.S. Cl. CPC G06F 9/3861; G06F 9/3814; G06F 9/3009; G06F 9/3806

(57) ABSTRACT

Embodiments are provided for reduction of lost cycles after branch misprediction in multi-thread microprocessors. In some embodiments, a method includes fetching, by first stage circuitry of a multi-thread microprocessor, a pair of consecutive instructions of a program executed in a thread. The method also includes determining, by second stage circuitry of said microprocessor, during a clock cycle, that a first instruction in the pair is a branch instruction. The method further includes fetching, by the first stage circuitry, during a second clock cycle, a pair of branch target instructions of the program using a branch prediction, and determining, by third stage circuitry of said microprocessor, during the second clock cycle, that the branch prediction is a misprediction. The method still includes sending the second instruction to the second stage circuitry during a third clock cycle, and decoding the second instruction by the second stage circuitry during the third clock cycle.

### BACKGROUND

Efficiency of a microprocessor increases with the number of instructions executed over multiple execution cycles. Executable program code, however, typically includes branches that can change the sequence of execution of instructions in the executable program code. As a result, in pipelined microprocessors, a branch represents a control hazard because the branch can cause the loss of processor cycles regardless the type of branch (e.g., an unconditional branch or conditional branch).

An approach to avoid losing processor cycles due to a branch is to use branch prediction with a branch target buffer. In that approach, a microprocessor predicts whether that branch is to be taken or not to be taken. Using such a prediction, the microprocessor obtains a speculative branch target address as a next instruction fetch. In cases the branch prediction is a hit, the microprocessor continues operation without loss of processor cycles. In cases the prediction is incorrect, the microprocessor flushes the speculatively fetched instruction using the branch target address and fetches the appropriate instruction using an adjusted address that is correct. Flushing the speculatively fetched instructions causes the loss of processor cycles. The number of lost processor cycles per branch misprediction quantifies a branch misprediction penalty in the pipelined microprocessor.

Although there are various branch prediction mechanisms, branch misprediction may not be avoided. Therefore, improved technologies for the reduction of branch misprediction penalty may be desired.

### SUMMARY

This disclosure addresses the issue of branch misprediction penalty, providing branch mechanisms that can reduce or avoid branch misprediction penalty.

According to an embodiment, the disclosure provides a multi-thread microprocessor. The multi-thread microprocessor includes comprising first stage circuitry that fetches a pair of consecutive instructions of a program executed in a thread of multiple threads. The multi-thread microprocessor also includes a second stage circuitry that determines, during a clock cycle, that a first instruction in the pair of consecutive instructions is a branch instruction. The first stage circuitry fetches, during a second clock cycle after the clock cycle, a pair of branch target instructions of the program using a branch prediction, where the second clock cycle follows the clock cycle without interruption. The multi-thread microprocessor further includes third stage circuitry that determines that the branch prediction is a misprediction during the second clock cycle. The first stage circuitry sends the second instruction to the second stage circuitry during a third clock cycle after the second clock cycle, wherein the third clock cycle follows the second clock cycle without interruption. In addition, the second stage circuitry decodes the second instruction during the third clock cycle.

According to another embodiment, the disclosure provides another multi-thread microprocessor. The multi-thread microprocessor includes first stage circuitry that determines, during a clock cycle, that a first instruction of a program executed in a thread of multiple threads is a branch instruction. The multi-thread microprocessor also includes second stage circuitry that fetches, during a second clock cycle after the clock cycle, a pair of branch target instructions of the program using a branch prediction, where the second clock cycle follows the clock cycle without interruption. The multi-thread microprocessor further includes third stage circuitry that determines that the branch prediction is a misprediction during the second clock cycle. The first stage circuitry decodes a first instruction of the pair of branch target instructions during a third clock cycle after the second clock cycle, where the third clock cycle follows the second clock cycle without interruption. The second stage circuitry fetches, during a fourth clock cycle after the third clock cycle, a pair of consecutive instructions of the program. The second stage circuitry sends an instruction of the pair of consecutive instructions to the first stage circuitry during a fifth clock cycle after the fourth clock cycle, where the fifth clock cycle follows the fourth clock cycle without interruption. The first stage circuitry decodes the instruction of the pair of consecutive instructions during the fifth clock cycle.

According to yet another embodiment, the disclosure provides a microcontroller unit. The microcontroller unit comprises a multi-thread microprocessor, including first stage circuitry that fetches a pair of consecutive instructions of a program executed in a thread. The microcontroller unit also includes second stage circuitry that determines, during a clock cycle, that a first instruction in the pair of consecutive instructions is a branch instruction. The first stage circuitry fetches, during a second clock cycle after the clock cycle, a pair of branch target instructions of the program using a branch prediction, where the second clock cycle follows the clock cycle without interruption. The microcontroller unit also includes third stage circuitry that determines that the branch prediction is a misprediction during the second clock cycle. The first stage circuitry sends the second instruction to the second stage circuitry during a third clock cycle after the second clock cycle, where the third clock cycle follows the second clock cycle without interruption. The second stage circuitry decodes the second instruction during the third clock cycle.

According to still another embodiment, the disclosure provides a method. The method includes fetching, by first stage circuitry of a multi-thread microprocessor, a pair of consecutive instructions of a program executed in a thread of multiple threads. The method also includes determining, by second stage circuitry of the multi-thread microprocessor, during a clock cycle, that a first instruction in the pair of consecutive instructions is a branch instruction. The method further includes fetching, by the first stage circuitry, during a second clock cycle after the clock cycle, a pair of branch target instructions of the program using a branch prediction, where the second clock cycle follows the clock cycle without interruption. The method also includes determining, by third stage circuitry of the multi-thread microprocessor, during the second clock cycle, that the branch prediction is a misprediction. The method still further includes sending the second instruction from a fetch buffer to the second stage circuitry during a third clock cycle after the second clock cycle, where the third clock cycle follows the second clock cycle without interruption. The method also includes decoding the second instruction by the second stage circuitry during the third clock cycle.

According to a further embodiment, the disclosure provides another method. The method includes determining, by first stage circuitry of a multi-thread microprocessor, during a clock cycle, that a first instruction of a program executed in a thread of multiple threads is a branch instruction. The method also includes fetching, by second stage circuitry of the multi-thread microprocessor, during a second clock cycle after the clock cycle, a pair of branch target instructions of the program using a branch prediction, where the second clock cycle follows the clock cycle without interruption. The method further includes determining, by a third stage circuitry of the multi-thread microprocessor, during the second clock cycle, that the branch prediction is a misprediction. The method also includes decoding, by the first stage circuitry, a first instruction of the pair of branch target instructions during a third clock cycle after the second clock cycle, where the third clock cycle follows the second clock cycle without interruption. The method further includes fetching, by the second stage circuitry, during a fourth clock cycle after the third clock cycle, a pair of consecutive instructions of the program. The method further includes sending an instruction of the pair of consecutive instructions from a fetch buffer to the first stage circuitry during a fifth clock cycle after the fourth clock cycle, where the fifth clock cycle follows the fourth clock cycle without interruption. The method also includes decoding, by the first stage circuitry, the instruction of the pair of consecutive instructions during the fifth clock cycle.

There are many ways to apply the principles of this disclosure in an embodiment. The above elements and associated technical improvements of this disclosure are examples, in a simplified form, of the application of those principles. The above elements and technical improvements and other elements and technical improvements of this disclosure are clear from the following detailed description when considered in connection with the annexed drawings.

### BRIEF DESCRIPTION OF THE DRAWINGS

FIG. 1 illustrates an example of a hardware multi-thread microprocessor, in accordance with one or more embodiments of this disclosure.

FIG. 2 illustrates an example of execution of program instructions in a pipeline of the hardware multi-thread microprocessor shown in FIG. 1, in accordance with one or more embodiments of this disclosure.

FIG. 3 illustrates an example of execution of program instructions in the multi-thread microprocessor shown in FIG. 1, for a missed branch prediction, in accordance with one or more embodiments of this disclosure.

FIG. 4 illustrates another example of execution of program instructions in the multi-thread microprocessor shown in FIG. 1, for a branch misprediction, in accordance with one or more embodiments of this disclosure.

FIG. 5 illustrates yet another example of execution of program instructions in the hardware multi-thread microprocessor shown in FIG. 1, for a branch misprediction, in accordance with one or more embodiments of this disclosure.

FIG. 6 illustrates branch misprediction penalty for the two possible branch scenarios after fetching a doubleword instruction, in accordance with one or more embodiment of this disclosure.

FIG. 7 illustrates an example of a method for mitigating branch misprediction penalty, in accordance with one or more embodiments of this disclosure.

FIG. 8 illustrates an example of another method for mitigating branch misprediction penalty, in accordance with one or more embodiments of this disclosure.

FIG. 9 illustrates an example of a microcontroller unit (MCU) that includes a hardware multi-thread microprocessor in accordance with one or more embodiments of this disclosure.

### DETAILED DESCRIPTION

Embodiments of this disclosure address the issue of branch misprediction penalty. Branch misprediction penalty in a pipelined microprocessor indicates the number of lost processor cycles per branch misprediction. In a pipelined hardware multi-thread microprocessor, branch misprediction can occur during execution of executable program code in a particular thread of multiple threads. In this disclosure, executable program code can be referred to as a program. Branch misprediction penalty can increase with the number of stages in the pipeline of a microprocessors. Advanced microprocessor having a pipeline with more than five stages can exhibit greater branch misprediction penalty.

Embodiments of this disclosure address such an issue by providing branch mechanisms that can reduce or avoid branch misprediction penalty during execution of a program. To that end, in some embodiments, a pipelined hardware multi-thread microprocessor can fetch a doubleword instruction to obtain a pair of consecutive sequential instructions and can buffer those sequential instructions. Detection of a branch instruction in the pair of consecutive sequential instructions causes the hardware multi-thread microprocessor to fetch another doubleword instruction in order to obtain a pair of branch target instructions. The branch target instructions can be fetched using a branch prediction, and also can be buffered. In turn, a determination that the branch prediction is a misprediction causes the multi-thread microprocessor to pass the non-branch instruction in the pair of consecutive instructions to decode stage circuitry of the hardware multi-thread microprocessor. The multi-thread microprocessor then fetches a doubleword instructions to obtain a subsequent pair of consecutive instructions, continuing with execution of the program thereafter. As a result, branch misprediction penalty can be avoided.

Embodiments of this disclosure provide several technical improvements. For example, by reducing and, in some cases, avoiding branch misprediction penalty, embodiments of this disclosure deliver greater processing efficiency relative to conventional hardware multi-thread microprocessors. Hardware multi-thread microprocessors of this disclosure can have processing efficiency that is improved by 5% relative those conventional microprocessors. These and other technical benefits can be realized through implementation of the embodiments described herein.

It is noted that for the sake of simplicity of explanation, the branch mechanisms of this disclosure are presented in connection with a particular thread T of multiple threads supported by the hardware multi-thread microprocessor 100. For instance, the multiple threads can include threads A and B, and T can be either A or B. Thus, in FIGS. 3 to 5, for example, instructions pertaining to T are explicitly labeled, whereas instructions for another thread are shown as blank rectangles. Although embodiments are disclosed in connection with dual-tread scenarios under alternating processing of instructions, the disclosure is not limited in that respect. Indeed, the principles of this disclosure be implemented for more than two threads.

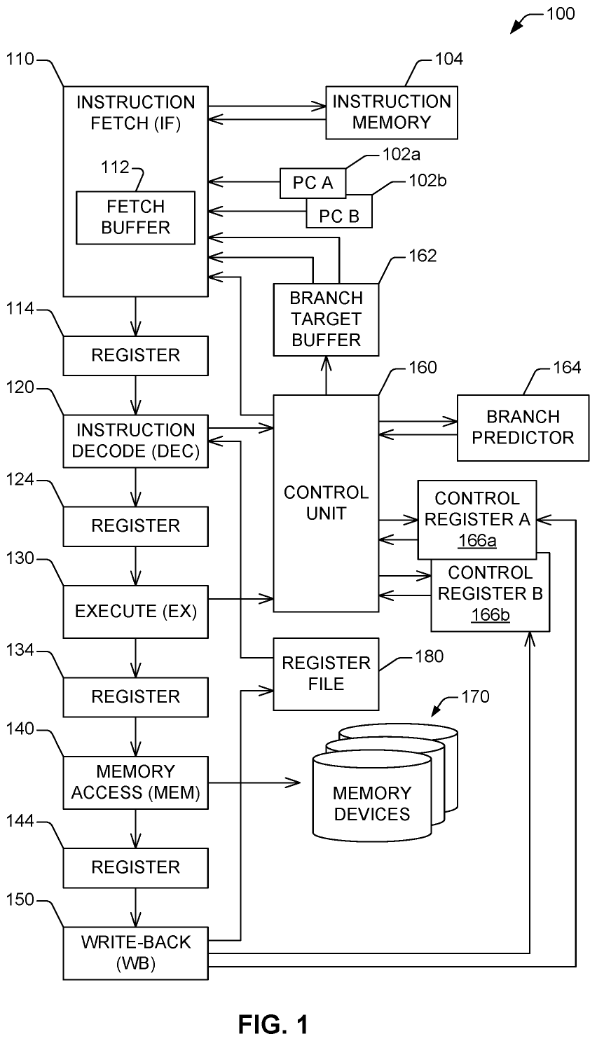

With reference to the drawings, FIG. 1 illustrates an example of a hardware multi-thread microprocessor 100, in accordance with one or more embodiments of this disclosure. As is illustrated in FIG. 1, the hardware multi-thread microprocessor 100 is a pipelined microprocessor that can support multiple thread operation. The hardware multi-thread microprocessor 100 can be integrated into a microcontroller unit (MCU) or another type of microcontroller device to provide processing functionality in accordance with aspects of this disclosure.

The hardware multi-thread microprocessor 100 includes a five-stage pipeline having an instruction fetch (IF) stage 110, an instruction decode (DEC) stage 120, an execute (EX) stage 130, and a memory access (MEM) stage 140, and a writeback (WB) stage 150. In some embodiments, the MEM stage 140 also can include execution circuitry and, thus, the MEM stage 140 represents a MEM/EX2 stage. Each of those stages is embodied in, or includes, processing circuitry.

The IF stage 110 obtains instructions to execute from a memory device. As such, the hardware multi-thread microprocessor 100 includes an instruction memory device 104 (referred to as instruction memory 104; an I-cache, for example) and multiple program counters (PCs). The multiple PCs include a first PC 102a and a second PC 102b. The IF stage 110 receives an address from a PC, such as PC 102a. The address points to a location in the instruction memory 104 that contains the instruction—a word having bits defining an opcode and operand data that constitute the instruction. In some embodiments, the word can span 32 bits. In other embodiments, the word can span 16 bits.

In some cases, the IF stage 110 can fetch a doubleword instruction defining a pair of consecutive instructions of a program executed in a particular thread of the hardware multi-thread microprocessor 100. As an example, the particular thread can be thread A. The doubleword instruction defines a first instruction and a second instruction of the program. The first and second instructions are consecutive instructions. In some embodiments, a doubleword can span 64 bits, where bits 0 to 31 constitute the low word and bits 32 to 63 constitute the high word. In other embodiments, the doubleword can span 32 bits, where bits 0 to 15 constitute the low word and bits 16 to 31 constitute the high word.

More specifically, the IF stage 110 can receive an address from a PC corresponding to the particular thread, e.g., PC 102a, and can generate a consecutive address by adding one to the received address. The IF stage 110 can then utilize the received address and the consecutive address to obtain a doubleword instruction from the instruction memory 104. The received address and the consecutive address form a doubleword address, wherein a first word of the doubleword address defines an address of the first instruction, and a second word of the doubleword address defines an address of the second instruction. Using the doubleword address, the IF stage 110 receives the doubleword instruction from the instruction memory 104. The low word of the doubleword instruction defines the first instruction and the high word of the doubleword instruction defines the second instruction.

The IF stage 110 also includes a fetch buffer 112 that can store a doubleword instruction that has been fetched before the constituent first instruction and second instruction are passed to the DEC stage 120. The first and second instructions are individually passed to the DEC stage 120, in respective consecutive clock cycles. It is noted that in some embodiments, instead of storing the doubleword instruction that has been fetched, the IF stage 110 can store one of constituent first or second instructions and can pass the other one of the constituent first or second instructions to the DEC stage 120. In other words, the IF stage 110 is not limited to storing an entire pair of instructions prior to passing an instruction in that pair to the DEC stage 120.

DEC stage 120 identifies an instruction type and prepares operand data to execute. In some cases, the DEC stage 120 can determine that an instruction is a branch instruction. The branch instruction can be a conditional instruction or unconditional instruction.

EX stage 130 performs actual data operations based on the operand data received from the DEC stage 120. MEM stage 140 accesses memory if an instruction is of load type or store type. Memory address is typically determined at EX state 130. That memory can be embodied in a particular memory device of multiple memory devices 170. The particular memory device can be external to the hardware multi-thread microprocessor 100, in some cases. The particular memory device can be volatile memory or non-volatile memory, and can include program memory or data memory, or both.

WB stage 150 writes a result operand into a register file 180 and/or a control register within the hardware multi-thread microprocessor 100. The register file 180 can include 16, 32, or 64 registers, for example. Although a single register file 180 is shown, it is noted that the hardware multi-thread microprocessor 100 includes a register file 180 per thread T of the multiple threads supported by the hardware multi-thread microprocessor 100. The control register can pertain to a particular thread executed by the hardware multi-thread microprocessor 100. For instance, the control register can be one of a control register 166a pertaining to a first thread or a control register 166b pertaining to a second thread. The result operand can be embodied in, for example, load data from memory or executed data from the EX stage 130.

Each stage can process data during a clock cycle, which also can be referred to as stage cycle or processor cycle. The clock cycle is determined by a clock frequency f of the hardware multi-thread microprocessor 100. In one example, f can have a magnitude of 100 MHz. After being processed during a clock cycle in one stage, data can be sent from that stage to another stage down the pipeline on a next clock cycle. To that end, the hardware multi-thread microprocessor 100 includes registers functionally coupling those stages. Each one of the registers serves as an input element to the stage that receives the data. In particular, to pass data from a first stage to a second stage, the first stage writes the data to the register coupling the first and second stages during a clock cycle. The second stage then reads the data from that register during a second clock cycle immediately after the clock cycle. The register is embodied in a storage device, such as a latch, a flip flop, or similar device. As is illustrated in FIG. 1, a register 114 functionally couples the IF stage 110 and the DEC stage 120; a register 124 functionally couples the DEC stage 120 and the EX stage 130; a register 134 functionally couples the EX stage 130 and the MEM stage 140; and a register 144 functionally couples the MEM stage 140 and the WB stage 150.

The register 114, register 124, register 134, and register 144 also constitute the five-stage pipeline of the hardware multi-thread microprocessor 100. The five-stage pipeline forms a core of the hardware multi-thread microprocessor 100. Because instructions are processed in sequence, the hardware multi-thread microprocessor 100 can be referred to as an in-order issue, in-order completion pipeline.

In some embodiments, the hardware multi-thread microprocessor 100 supports two threads. In those embodiments, the multi-thread microprocessor 100 can execute two different programs concurrently within a single core by interleaving instructions. Interleaved execution allows parallel execution of two or more programs within a single core. In addition, overall execution speed can be improved because interleaved execution can hide some latency by allowing one thread to run even when the other thread is stalled. Or it could save run time by reducing the overall stall time if both threads stalled.

As is illustrated in FIG. 1, a first program counter 102a corresponds to a first thread and a second program counter 102b corresponds to a second thread. The hardware multi-thread microprocessor 100 also includes a thread identifier (ID) generator (not depicted in FIG. 1, for the sake of clarity) that indicates which program counter (PC) is to be used during each fetch. In addition, because each thread can produce different flags, the single core also can be functionally coupled to two control registers: the first control register 166a for the first thread and the second control register 166b for the second thread. The first thread and the second thread are labeled “A” and “B”, respectively, simply for the sake of nomenclature and clarity of the description hereinafter.

The first control register 166a and second control register 166b can be written or read simultaneously by various stages, including DEC stage 120 for reading registers for multiply operations, EX stage 130 for reading register values for non-multiply operations, and WB stage 150 for writing results back to registers.

The control unit 160 allows thread A and thread B operations to occur simultaneously. This is important because the control unit 160 can receive simultaneously a request to write a particular register from DEC stage 120 and a request to read that particular register from EX stage 130, or there may be a request to write back a value in WB stage 150 while there is a request to read a value in EX stage 130, and data coherency requires that all of these reads and writes be handled concurrently, which requires they all be on the same thread. The control unit 160 in this case provides the data value directly to the reading stage from the writing stage, simultaneously writing the new value into the required register.

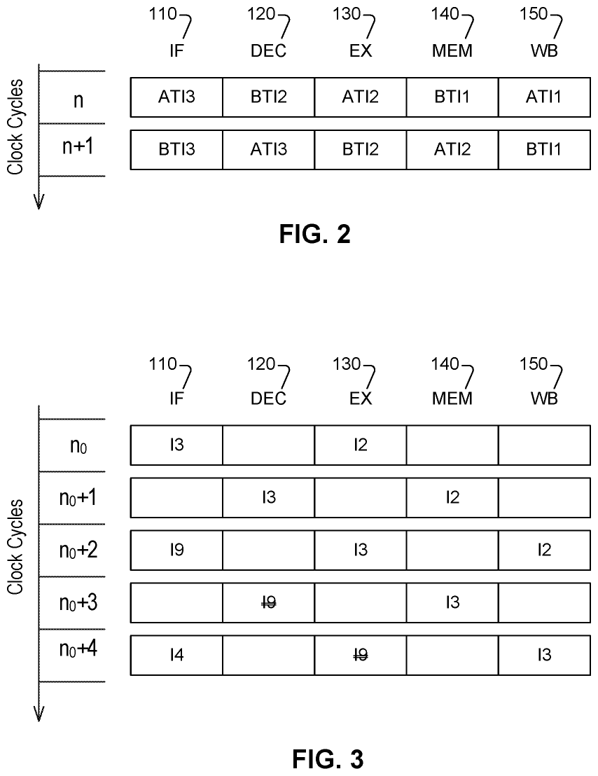

An executable program corresponding to a thread A can have an ordered sequence of instructions {ATI1, ATI2, ATI3, ATI4, . . . }. In turn, another executable program corresponding to a thread B can have a sequence of instructions {BTI1, BTI2, BTI3, BTI4, . . . }. The instructions in those programs are executed in interleaving manner, meaning that the hardware multi-thread microprocessor 100 fetches instructions by alternating the executable programs. As is illustrated in FIG. 2, in the pipeline, an example of an instruction execution snapshot at time t=n is ATI3, BTI2, ATI2, BTI1, ATI1. Here n represents the n-th clock cycle of the hardware multi-thread microprocessor 100. An example of an instruction execution snapshot at time t=n+1 is BTI3, ATI3, BTI2, ATI2, BTI1. Interleaved execution of the two executable programs is equivalent to having two f/2 single-thread microprocessor within one f dual-thread microprocessor.

In some cases, a program executed in thread A can include one or several branch instructions. Similarly, another program executed in thread B also can include one or several branch instructions. Branch instructions are decoded at DEC stage 120. Some branch instructions need register value as base. Also, branch conditions can be resolved at the end of the EX stage 130. Upon resolving a branch condition, the EX stage 130 can direct the control unit 160 to flush or accept branch instruction(s). If the flag values are not forwarded to DEC stage 120, then branch result can be found in the EX stage 130, since the earliest conditional flag result can be found at MEM stage 140.

In response to identification of a branch instruction by the DEC stage 120, the control unit 160 can read a branch prediction from a branch predictor component 164 (referred to as branch predictor 164). In some embodiments, the branch predictor component 164 can be flip-flop with appropriate logic. The branch prediction is a speculatively assertion of whether the branch corresponding to the branch instructions is to be taken or not to be taken. The control unit 160 then causes a branch target buffer 162 to pass at least one address of respective branch target instructions to the IF stage 110. For instance, two such addresses can be passed, where each address being passed is represented by an arrow in FIG. 1. The control unit 160 also can cause the IF stage 110 to use the at least one address being passed instead of using an address from a PC (PC 102a or PC 106b, for example) in order to fetch an instruction from instruction memory 104. The branch predictor 164 can be embodied in, for example, a 1-bit branch predictor or a 2-bit branch predictor. The 1-bit branch predictor stores 1-bit values, each indicating one of branch taken prediction or branch not-taken prediction. Those 1-bit values represent respective branch predictions for branch instructions. A first 1-bit value of the 1-bit values can be flipped in response to a branch misprediction. The 2-bit branch predictor stores 2-bit values representing respective branch predictions for branch instructions. For instance, each one of “00” and “01” can predict branch not-taken and each one of “10” and “11” can predict branch taken. Because a 2-bit value renders a prediction, the 2-bit predictor switches a prediction when two successive branch mispredictions occur. This disclosure, however, is not limited to those types of branch predictors. The branch target buffer 162 can be embodied in a 32-bit or a 64-bit buffer, for example.

FIG. 3 illustrates a scenario where branch prediction in the hardware multi-thread microprocessor 100 has failed and yet branch misprediction penalty is one clock cycle. In such a scenario, an instruction that is obtained by the IF stage 110 is a branch instruction of executable program code executed in the particular execution thread T of multiple execution threads (e.g., A and B). Specifically, during a clock cycle no, the IF stage 110 fetches the branch instruction. The branch instruction can be prefetched and stored into the fetch buffer 112 (FIG. 1). Simply for the sake of illustration, the branch instruction is represented by instruction I3.

The instruction I3 is one clock cycle before an initial instruction in the branch corresponding to the instruction I3. It is noted that, in some cases, the initial instruction could be the only instruction in the branch. The IF stage 110 can fetch a branch target instruction speculatively during a clock cycle n₀,+2, while the instruction I3 is in the EX stage 130. That is, the branch target instruction can be fetched using a branch prediction as to whether the branch is taken or not taken. As an illustration, the target branch instruction is represented by instruction I9.

Execution of the instruction I3 provides an actual outcome as to whether the branch is taken or not taken. Thus, in one scenario, the EX stage 130 can determine that the branch prediction utilized to fetch the branch target instruction is a misprediction. In response, the fetched instruction I9 is cancelled due to branch prediction failure in a subsequent clock cycle n₀,+3. Cancellation of the instruction is represented by double-strikethrough lines in FIG. 3. The cancelled target branch instruction is transferred to the DEC stage 120 during the clock cycle n₀,+3.

In further response to the branch prediction being a misprediction, the IF stage 130 can fetch a sequential instruction during a clock cycle n₀,+4. In FIG. 3, the sequential instruction is illustrated as instruction I4. During clock cycle n₀,+4, the cancelled instructions I9 is received by the EX stage 130 and the instruction I3 is received by the WB stage 150 and processed accordingly. Execution of the executable program code can then continue for the particular program thread T.

Therefore, in the scenario depicted in FIG. 3, the branch misprediction penalty is one clock cycle as a result of speculatively fetching the target branch instructions I9 instead of fetching the pair of sequential instructions (I4,I3). Such a branch misprediction penalty is revealed in FIG. 3 by the presence of the row corresponding to clock cycle n₀,+2, which results from the misprediction of the target branch instructions I9.

Because in dual-thread execution two different programs run on the same pipeline in an interleaving manner, the one clock-cycle penalty is half the penalty that is present in a single-thread microprocessor in case of branch misprediction. In other words, by executing programs in respective threads in the hardware multi-thread microprocessor 100, the branch misprediction penalty is reduced by a single cycle relative to the hardware single-thread microprocessors.

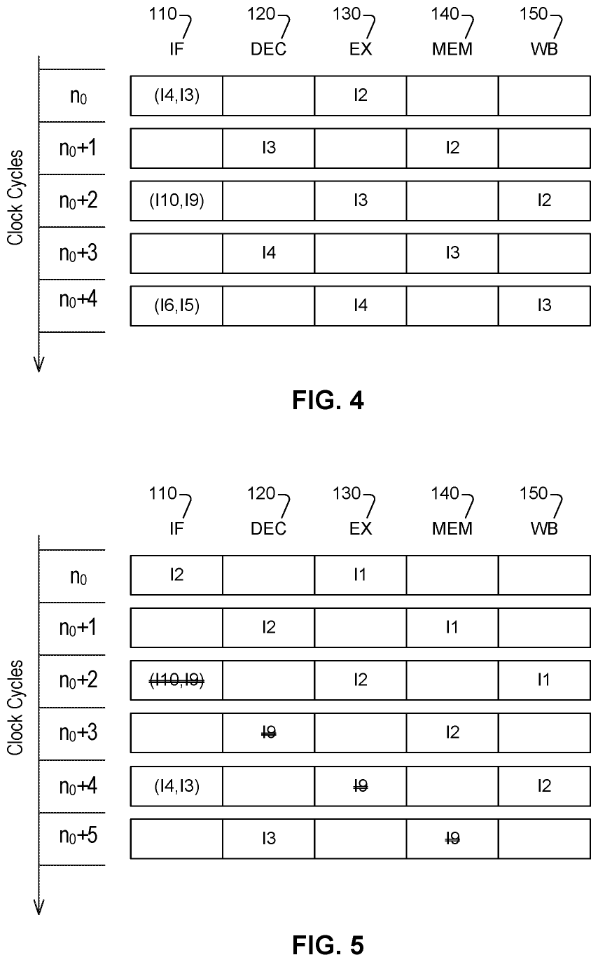

In some embodiments, the hardware m multi-thread microprocessor 100 can mitigate branch penalty by using doubleword instruction fetch and the fetch buffer 112 in the IF stage 110. FIG. 4 illustrates an example of a scenario where branch prediction has failed and yet there is no branch penalty. During a clock cycle no, the IF stage 110 fetches a doubleword. The doubleword defines a first instruction and a second instruction of a program executed in a particular thread of the hardware multi-thread microprocessor 100. The first and second instructions are consecutive instructions. Specifically, a first word of the doubleword address defines an address of the first instruction, and a second word of the doubleword address defines an address of the second instruction.

For the sake of illustration, in FIG. 4, the doubleword that is fetched is shown as (I4,I3) and represents an instruction I3 and a consecutive instruction I4. In this example scenario, I3 is a branch instruction. The DEC stage 120 can determine that I3 is a branch instruction by decoding I3 during a next clock cycle n₀+1. In response to such a determination, during a subsequent clock cycle n₀+2 (e.g., two clock cycles after fetching (I4, I3)) the IF stage 110 can fetch a second doubleword instruction defining a first branch target instruction and a second branch target instruction.

The particular first and second branch target instructions that are fetched can be dictated by a branch prediction. Such a fetch can thus be referred to as a speculative fetch. As an illustration, in FIG. 4, the second doubleword instructions is shown as (I10,I9) and represents a branch target instruction I9 and a branch target instruction I10. The EX stage 130 can execute instruction I3 also during the clock cycle n₀+2. As a result, the EX stage 130 can determine that the branch prediction has failed. In other words, the EX stage 130 determines that the branch corresponding to instruction I3 is not to be taken. Thus, the next instruction to be processed is instruction I4.

Accordingly, in response to determining that branch prediction has failed, instruction I4 can be passed to the DEC stage 120 in a following clock cycle n₀+3. Because instruction I4 is prefetched and stored in the fetch buffer 112 (FIG. 1), there is no branch penalty even after the branch prediction has failed. That is, instruction I4 is decoded during a consecutive interleaved clock cycle relative to the decoding of the instruction I3, without delay. Therefore, the sequential processing of instructions in the particular thread T can proceed unaltered.

The PC corresponding to the particular thread T can be updated accordingly. The IF stage 110 can then fetch a third doubleword instruction during a next clock cycle n₀+4. The third doubleword instruction defines a third instruction and a fourth instruction of the program executed in the particular thread. For the sake of illustration, the third doubleword instruction that is fetched is shown as (I6,I5) in FIG. 4 and represents an instruction I5 and an instruction I6. The third and fourth instructions are sequential to the first and second instructions (e.g., I3 and I4) defined by the second doubleword fetched in clock cycle no. Accordingly, execution of the program can continue for the particular thread.

FIG. 5 illustrates a scenario where branch prediction has failed and branch misprediction penalty is one clock cycle. In this scenario, an instruction that is obtained by the IF stage 110 is a branch instruction of a program executed in a particular thread of multiple threads. Specifically, during a clock cycle no, the IF stage 110 fetches the branch instruction. The branch instruction can be prefetched and stored into the fetch buffer 112 (FIG. 1). Simply for the sake of illustration, the branch instruction is represented by instruction I2. In some cases, I2 can be a prefetched instruction that has been retained in the fetch buffer 112. That is, I2 can be the second-read instructions in a pair of consecutive instructions that has been prefetched.

The instruction I2 is one clock cycle before an initial instruction in the branch corresponding to the instruction I2. In cases when the branch includes two or more instructions, the IF stage 110 fetches a doubleword instruction defining a pair of target branch instructions including a first target branch instruction and a consecutive second target branch instruction. The doubleword instruction is fetched speculatively during a clock cycle n₀,+2, while the instruction I2 is in the EX stage 130. That is, the doubleword instruction can be fetched using a branch prediction. As an illustration, the first and second target branch instructions are represented by instruction I9 and instruction I10, respectively. It is noted that, in some cases, the initial instruction could be the only instruction in the branch. In those cases, the second word of the doubleword instruction can contain the target address of the target instruction in the first word of the doubleword. Other data padding also can be used in those cases.

Execution of the instruction I2 provides an actual outcome as to whether the branch is taken or not taken. Thus, in one scenario, the EX stage 130 can determine that the branch prediction utilized to fetch the doubleword instruction is a misprediction. In response, the fetched instructions I9 and I10 are cancelled due to branch prediction failure while the branch instruction I2 is in EX stage 130. Cancellation of the doubleword instruction is represented by double-strikethrough lines in FIG. 5. The cancelled first target branch instruction in the fetched pair of target branch instructions is then passed to the DEC stage 120 during a clock cycle n₀,+3.

In further response to the branch prediction being a misprediction, the IF stage 110 can fetch a second doubleword instruction during a clock cycle n₀,+4. The second doubleword instruction defines a pair of consecutive instructions of the executable program code. In FIG. 5, the pair of consecutive instructions is illustrated as having an instruction I3 and a consecution instruction I4.

During a clock cycle n₀,+5, an instruction (e.g., I3) of the pair of consecutive instructions is sent from the fetch buffer 112 (FIG. 1) to the DEC stage 120. Such an instruction can be decoded and execution of the executable program code can continue for the particular program thread T.

Therefore, in the scenario depicted in FIG. 5, the branch misprediction penalty is one clock cycle as a result of speculatively fetching the pair of target branch instructions (I10,I9) instead of fetching the pair of sequential instructions (I4,I3). Such a branch misprediction penalty is revealed in FIG. 5 by the presence of the row corresponding to clock cycle n₀,+3, which results from the misprediction of the pair of target branch instructions (I10,I9).

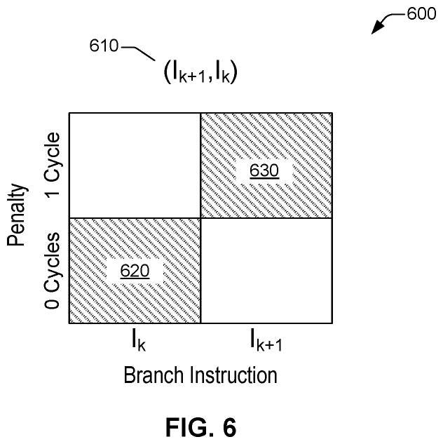

FIG. 6 illustrates a diagram 600 summarizing branch misprediction penalty for the two possible branch scenarios after fetching a doubleword instruction 610 represented by a pair of consecutive instructions (Iₖ₊₁,Iₖ), with k an index that identifies an instruction. The instruction Iₖ can be referred to as the first-read instruction, and the instruction Iₖ₊₁ can be referred to as the second-read instruction. In a scenario in which Iₖ is a branch instruction and Iₖ₊₁ is a non-branch instruction, a branch mechanism of this disclosure results in a null branch misprediction penalty, represented by area 620 in the diagram 600. In another scenario in which Iₖ is a non-branch instruction and Iₖ₊₁ is a branch instruction, the branch mechanism of this disclosure results in a 1-cycle branch misprediction penalty, represented by block 630 in diagram 600.

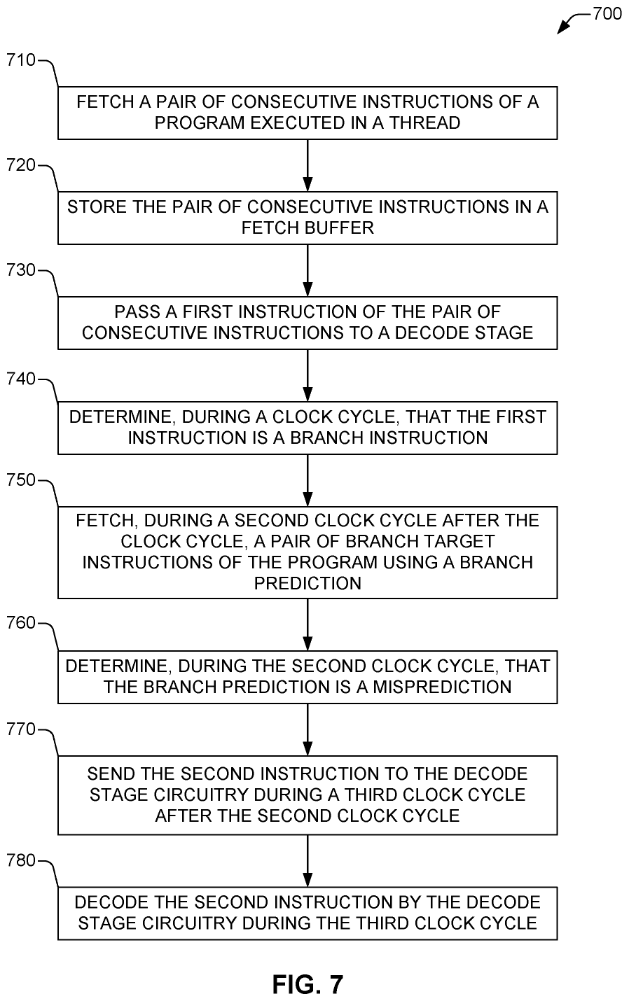

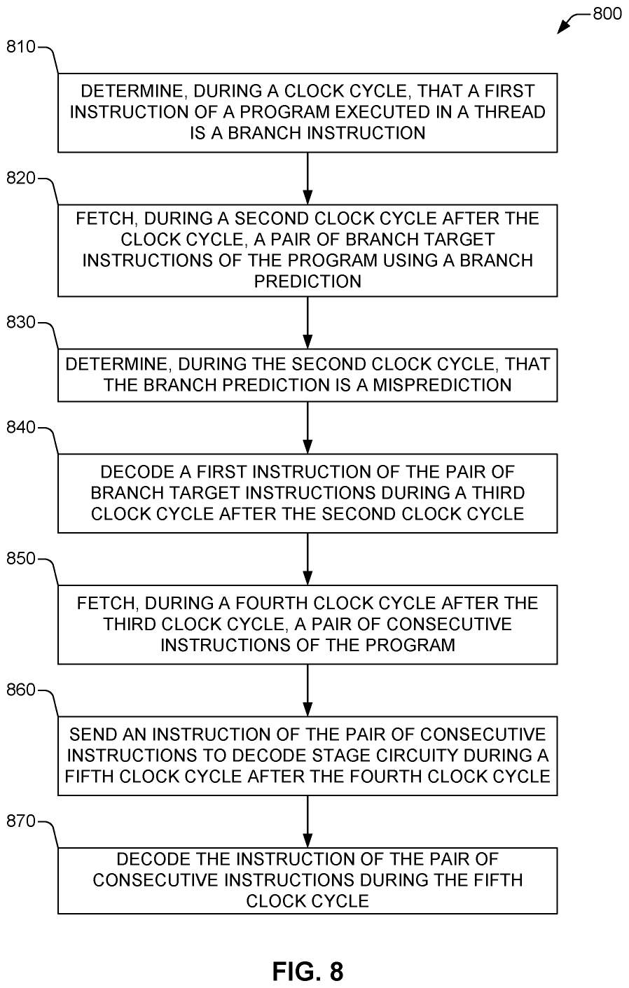

In view of the various aspects described herein, an example of the methods that can be implemented in accordance with this disclosure can be better appreciated with reference to FIG. 7 and FIG. 8. For purposes of simplicity of explanation, the example methods (and other techniques disclosed herein) are presented and described as a series of operations. It is noted, however, that the example methods and any other techniques of this disclosure are not limited by the order of operations. Some operations may occur in different order than that which is illustrated and described herein. In addition, or in the alternative, some operations can be performed essentially concurrently with other operations (illustrated or otherwise). Further, not all illustrated operations may be required to implement an example method or technique in accordance with this disclosure. Furthermore, in some embodiments, two or more of the example methods and/or other techniques disclosed herein can be implemented in combination with one another to accomplish one or more elements and/or technical improvements disclosed herein.

FIG. 7 is a flowchart of an example of a method 700 for mitigating branch misprediction penalty, in accordance with one or more embodiments of this disclosure. As mentioned, branch misprediction can occur during execution of executable program code in a particular thread of multiple execution threads. Here, the executable program code is referred to as a program. The method 700 can be performed by a hardware multi-thread microprocessor that includes a pipeline having multiple stages, each having processing circuitry. The processing circuitry can be referred to as stage circuitry. In one example, the hardware multi-thread microprocessor is embodied in the hardware multi-thread microprocessor 100 (FIG. 1). The order of the acts depicted in FIG. 7 is illustrative. In some cases, other orders of those acts also can constitute the example method 700. In addition, or in other cases, two or more of the acts illustrated in FIG. 7 can be performed concurrently.

At act 710, first stage circuitry of the hardware multi-thread microprocessor fetches a pair of consecutive instructions of a program executed in a thread within multiple threads. The pair of instructions can be fetched using a doubleword address. A first word (e.g., low word) of the doubleword address defines an address of a first instruction in the pair of consecutive instructions. A second word (e.g., high word) of the doubleword address defines an address of a second instruction in the pair of consecutive instructions. The first stage circuitry can be embodied in the IF stage 110 (FIG. 1).

At act 720, the first stage circuitry can store the pair of consecutive instructions can be stored in a memory device. The memory device can be included in the first stage circuitry or can be functionally coupled thereto. For instance, the memory device can be embodied in the fetch buffer 112 (FIG. 1).

At act 730, the first stage circuitry can pass a first instruction of the pair of consecutive instructions to a second stage circuitry of the hardware multi-thread microprocessor. The first instruction can be, for example, a first-read instruction. More specifically, in an instance in which the pair of instructions is (Iₖ₊₁,Iₖ), the first instruction can be Iₖ. The second stage circuitry is referred to as decode stage circuitry and can be embodied in the DEC stage 120 (FIG. 1).

It is noted that in some embodiments, instead of storing the pair of consecutive instructions in the memory device and then passing those instructions to the second stage circuitry, the first stage circuitry can store a first instruction in the pair of consecutive instructions and can pass a second instruction in the pair of consecutive instructions to the second stage circuitry.

At act 740, the second stage circuitry determines, during a clock cycle, that a first instruction in the pair of consecutive instructions is a branch instruction. To that end, the second stage circuitry can decode the first instruction.

At act 750, the first stage circuitry fetches, during a second clock cycle after the clock cycle, a pair of branch target instructions of the executable program code using a branch prediction. The second clock cycle follows the clock cycle without interruption. The branch prediction can be based on one of various branch predictor components, such as a 1-bit branch predictor or a 2-bit branch predictor. The pair of branch target instructions is fetched using a second doubleword address.

At act 760, third stage circuitry of the multi-thread microprocessor determines, during the second clock cycle, that the branch prediction is a misprediction. To that end, the third stage circuitry can execute the first instruction of the pair of consecutive instructions. The third stage circuitry is referred to as execute stage circuitry and can be embodied in the EX stage 130 (FIG. 1).

At act 770, the first stage circuitry sends the second instruction from the memory device (e.g., fetch buffer 112 (FIG. 1)) to the decode stage circuitry during a third clock cycle after the second clock cycle. The third clock cycle follows the second clock cycle without interruption. At act 780, the second stage circuitry decodes the second instruction during the third clock cycle.

While not illustrated in FIG. 7, in some embodiments, the example method 700 can include fetching, by the first stage circuitry, during a fourth clock cycle after the third clock cycle a second pair of consecutive instructions of the program. The example method 700 also can include executing the second instruction of the pair of consecutive instructions from act 710 during the fourth clock cycle. The third stage circuitry can execute the second instruction. The fourth clock cycle follows the third clock cycle without interruption.

FIG. 8 is a flowchart of an example of a method 800 for mitigating branch misprediction penalty, in accordance with one or more embodiments of this disclosure. Again, branch misprediction can occur during execution of executable program code in a particular thread of multiple execution threads. Here, the executable program code is referred to as a program. The method 800 can be performed by a hardware multi-thread microprocessor that includes a pipeline having multiple stages, each having processing circuitry. In one example, the hardware multi-thread microprocessor is embodied in the hardware multi-thread microprocessor 100 (FIG. 1). The hardware multi-thread microprocessor that performs the example method 600 also can perform the example method 800, in some embodiments. The order of the acts depicted in FIG. 8 is illustrative. In some cases, other orders of those acts also can constitute the example method 800. In addition, or in other cases, two or more of the acts illustrated in FIG. 8 can be performed concurrently.

At act 810, first stage circuitry of the hardware multi-thread microprocessor determines, during a clock cycle, that a first instruction of a program executed in a thread within multiple threads is a branch instruction. The first instruction can be prefetched an stored in a memory device (e.g., fetch buffer 112 (FIG. 1)). In some cases, the first instruction can be a second-read instruction in a pair (Iₖ₊₁,Iₖ). That is, the first instruction can be Iₖ₊₁. The first stage circuitry can be embodied in the IF stage 110 (FIG. 1).

At act 820, second stage circuitry of the hardware multi-thread microprocessor fetches, during a second clock cycle after the clock cycle, a pair of branch target instructions of the executable program code using a branch prediction. The second clock cycle follows the clock cycle without interruption. The second stage circuitry is referred to as decode stage circuitry and can be embodied in the DEC stage 120 (FIG. 1).

At act 830, the first stage circuitry fetches, during a second clock cycle after the clock cycle, a pair of branch target instructions of the program using a branch prediction. The second clock cycle follows the clock cycle without interruption. The branch prediction can be based on one of various branch predictor components, such as a 1-bit branch predictor or a 2-bit branch predictor. The pair of branch target instructions is fetched using a double-word address.

At act 840, the first stage circuitry decodes a first instruction of the pair of branch target instructions during a third clock cycle after the second clock cycle. The third clock cycle follows the second clock cycle without interruption.

At act 850, the second stage circuitry fetches, during a fourth clock cycle after the third clock cycle, a pair of consecutive instructions of the executable program code. The fourth clock cycle follows the third clock cycle without interruption. The pair of consecutive instructions is fetched using a second doubleword address. As mentioned, the first word (e.g., low word) of the doubleword address defines an address of an instruction in the pair, and a second word (high word) of the doubleword address defines an address of another instruction of the pair.

At act 860, an instruction of the pair of consecutive instructions can be sent from the fetch buffer to the first stage circuitry during a fifth clock cycle after the fourth clock cycle. The fifth clock cycle follows the fourth clock cycle without interruption. At act 870, the first stage circuitry decodes the instruction of the pair of consecutive instructions during the fifth clock cycle.

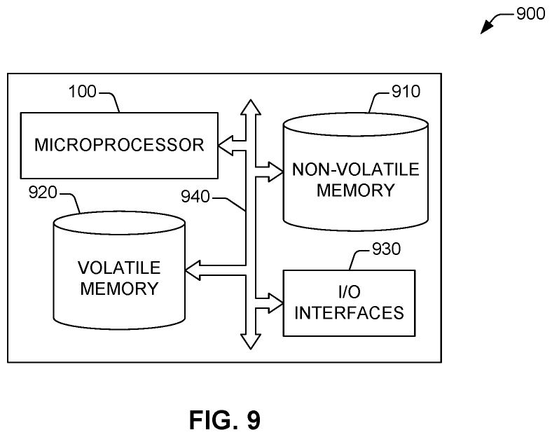

FIG. 9 is a schematic block diagram of an example of an MCU 900 that includes the hardware multi-thread microprocessor 100 described herein. The MCU 900 can implement the branch mechanisms for mitigation of branch penalty in accordance with aspects described herein. For example, by means of the hardware multi-thread microprocessor 100, the MCU 900 can perform the example methods in FIG. 7 and FIG. 8 described above. The components of the MCU 900 can be packaged into a single chipset.

In addition to the hardware multi-thread microprocessor 100, the MCU 900 includes several memory devices. The memory devices include one or many non-volatile (NV) memory devices 910 (referred to as NV memory 910). The NV memory 910 includes program memory storing program instructions that constitute an executable program. The hardware multi-thread microprocessor 100 can execute the executable program in one or many of multiple threads. Multiple copies of the executable program need not be stored in the program memory in order to execute multiple threads of the executable program. Thus, size requirements of the program memory can be constrained. In some embodiments, the NV memory 910 also includes data memory. The NV memory 910 can include one or more of ROM, EPROM, EEPROM, flash memory, or another type of non-volatile solid-state memory.

The memory devices in the MCU 900 also include and one or many volatile memory devices (referred to as volatile memory 920). The volatile memory 920 includes data memory storing data that is used for or results from execution of program instructions retained in the NV memory 910. The NV memory 910 can include one or more of SRAM, DRAM, or another type of volatile solid-state memory.

The MCU 900 also includes several input/output (I/O) interfaces 930 that, individually or in a particular combination, permit sending data to and/or receiving data from a peripheral device. The I/O interfaces 930 can be addressed individually by the hardware multi-thread microprocessor 100. The I/O interfaces 630 can include serial ports, parallel ports, general-purposed I/O (GPIO) pins, or a combination of those.

The MCU 900 further includes a bus 940 that includes a data bus, an address bus, and a control bus. The bus 940 permits the exchange of data and/or control signals between two or more of the hardware multi-thread microprocessor 100, the NV memory 910, the volatile memory 920, and the I/O interfaces 930.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method, comprising:
fetching, by first stage circuitry of a multi-thread microprocessor, a pair of consecutive instructions of a program executed in a thread of multiple threads;
determining, by second stage circuitry of the multi-thread microprocessor, during a clock cycle, that a first instruction in the pair of consecutive instructions is a branch instruction;
fetching, by the first stage circuitry, during a second clock cycle after the clock cycle, a pair of branch target instructions of the program using a branch prediction, wherein the second clock cycle follows the clock cycle without interruption;
determining, by third stage circuitry of the multi-thread microprocessor, during the second clock cycle, that the branch prediction is a misprediction;
sending the second instruction from a fetch buffer to the second stage circuitry during a third clock cycle after the second clock cycle, wherein the third clock cycle follows the second clock cycle without interruption; and
decoding the second instruction by the second stage circuitry during the third clock cycle.

2. The method of claim 1, further comprising,
fetching, by the first stage circuitry, during a fourth clock cycle after the third clock cycle a second pair of consecutive instructions of the program; and
executing, by the third stage circuitry, the second instruction during the fourth clock cycle, wherein the fourth clock cycle follows the third clock cycle without interruption.

3. The method of claim 1, wherein the pair of consecutive instructions is fetched using a doubleword address, a first word of the doubleword address defining an address of the first instruction and a second word of the doubleword address defining an address of the second instruction.

4. The method of claim 3, further comprising storing the first instruction and the second instruction in the fetch buffer.

5. The method of claim 3, wherein the doubleword address has a width of 64 bits or 32 bits.

6. The method of claim 1, wherein the pair of branch target instructions is fetched using a second doubleword address, a first word of the second doubleword address defining an address of a first branch target instruction of the pair of branch target instructions and a second word of the second doubleword address defining an address of a second branch target instruction of the pair of target branch instructions; and

7. The method of claim 6, further comprising storing the first branch target instruction and the second branch target instruction in the fetch buffer.

8. The method of claim 6, wherein the second doubleword address has a width of 64 bits or 32 bits.

9. The method of claim 1, wherein the branch prediction is based on one of a 1-bit branch predictor or a 2-bit branch predictor.

10. A method, comprising:
determining, by first stage circuitry of a multi-thread microprocessor, during a clock cycle, that a first instruction of a program executed in a thread of multiple threads is a branch instruction;
fetching, by second stage circuitry of the multi-thread microprocessor, during a second clock cycle after the clock cycle, a pair of branch target instructions of the program using a branch prediction, wherein the second clock cycle follows the clock cycle without interruption;
determining, by a third stage circuitry of the multi-thread microprocessor, during the second clock cycle, that the branch prediction is a misprediction;
decoding, by the first stage circuitry, a first instruction of the pair of branch target instructions during a third clock cycle after the second clock cycle, wherein the third clock cycle follows the second clock cycle without interruption;
fetching, by the second stage circuitry, during a fourth clock cycle after the third clock cycle, a pair of consecutive instructions of the program;
sending an instruction of the pair of consecutive instructions from a fetch buffer to the first stage circuitry during a fifth clock cycle after the fourth clock cycle, wherein the fifth clock cycle follows the fourth clock cycle without interruption; and
decoding, by the first stage circuitry, the instruction of the pair of consecutive instructions during the fifth clock cycle.

11. The method of claim 10, wherein the pair of consecutive instructions is fetched in a doubleword address, a first word of the doubleword address defining an address of a second instruction and a second word of the doubleword address defining an address of a third instruction of the pair of consecutive instructions.

12. The method of claim 11, further comprising storing the second instruction and the third instruction in the fetch buffer.

13. The method of claim 11, wherein the doubleword address has a width of 64 bits or 32 bits.

14. The method of claim 11, wherein the pair of branch target instructions is fetched using a second doubleword address.

15. The method of claim 14, further comprising storing the first branch target instruction and the second branch target instruction in the fetch buffer.

16. The method of claim 14, wherein the second doubleword address has a width of 64 bits or 32 bits.

17. The method of claim 10, wherein the branch prediction is based on one of a 1-bit branch predictor or a 2-bit branch predictor.
